(19) United States
(12) Patent Application Publication
(10) Pub. No.: US 2023/0143094 A1
(43) Pub. Date: May 11, 2023

(54) CONTACT IDENTIFICATION ATTACHMENT FOR ELECTRICAL CONNECTORS

(71) Applicant: Preddio Technologies Inc., North Andover, MA (US)

(72) Inventors: Aaron T. Ganick, Boxford, MA (US); Steven P. Marian, Wrentham, MA (US); Brian Rheaume, Westford, MA (US); Ronald K. Hart, Middleton, MA (US)

(21) Appl. No.: 18/053,979

(22) Filed: Nov. 9, 2022

Related U.S. Application Data
(60) Provisional application No. 63/263,925, filed on Nov. 11, 2021.

(51) Int. Cl. H01R 13/46

(52) U.S. Cl. CPC H01R 13/465

(57) ABSTRACT

A method and system for contact identification on a connector is provided. Specifically, a contact identification attachment to be affixed onto a connector may include an insert containing a plurality of cutouts and one or more indicators corresponding to the cutouts. The cutouts may correspond to the contacts on the connector. Using the indicators as aids, a user may connect proper wires to the proper contacts on the connector.

### CROSS-REFERENCE TO RELATED APPLICATION

This application claims the benefit of the filing date of U.S. Provisional Application Ser. No. 63/263,925 filed Nov. 11, 2021, entitled, “Contact Identification Attachment For Electrical Connectors”, which is hereby incorporated by reference as if fully set forth herein.

### BRIEF SUMMARY OF THE INVENTION

This disclosure generally relates to electrical connectors. Specifically, this disclosure relates to identification of contact positions for electrical connectors. In particular, this disclosure relates to an attachment that may be retrofitted onto electrical connectors in order to provide aid for contact position identification and ease of wire termination and intended connectivity.

### BACKGROUND OF THE INVENTION

Field terminated connectors such as a M8 or a M12 style circular connectors are widely used in industrial settings as well as in commercial environments. By way of example, connectors may be used in industrial automations to securely connect various devices. Certain connector styles (such as but not limited to M12 for example) may be suited for fieldbus connections, while other connector styles (such as but not limited to M8 for example) may be suited for industrial sensors.

A connector may include a plurality of male or female contacts in various configurations such as solder and screw type used for various purposes. For example, certain contacts may be used for certain types of signals and connections, while other contacts may be used for power connections.

Using a M12 connector as an example, as shown in FIGS. 1A and 1B, such a connector may include 2, 3, 4, 5, 6, 8, 12, or 17 contacts. Thus, attempting to identify and connect wires to correct corresponding contacts may be challenging and difficult—especially in a field setting—and wiring errors may cause a system malfunction and may cause damage to corresponding devices or equipment.

Several solutions exist that attempt to address the complexity of wiring a connector appropriately. For example, wiring diagrams may be provided to a user instructing the user to connect a certain color wire or a wire originating from a certain location to a certain connector contact.

Due to the wide variation in end-user configuration and use, connector manufactures typically provide connectors with contact designations as a method of identifying contact orientations of such connectors. However, given what is often a small size of a connector, identifying the corresponding pin number or the correct connector orientation may be challenging in practice.

Further, it is also possible that multiple wiring diagrams may be used with the same connector depending on the specific device to be connected and the required functionality. Providing multiple wiring diagrams to the user may further add to the complexity and confusion of properly wiring the connector, thus increasing time, labor cost, and chance of mis-wire.

Moreover, wiring diagrams may be lost or easily misinterpreted, contact identification may be small, inconveniently located, difficult to interpret, and connector orientation may be misconstrued, all of which may result in incorrect wiring.

In some connectors (such as the one shown in FIGS. 2A and 2B), the connector manufacturer may provide color codes integral to the connector plastic or insulator as means of identifying pin numbers. However, such an approach remains static and non-configurable, and does not aid the end user with their specific application or functionality that may differ or vary from the manufacturer's set configuration. As such, there remains a need to provide a flexible, configurable, and easy-to-comprehend field wiring instruction solution that may be configured as needed to accommodate infinite wiring, conductor color code, and functionality configurations required by each specific application.

### BRIEF DESCRIPTION OF THE DRAWINGS

FIG. 1A illustrates a side-view of a M12 style connector known in the art;

FIG. 1B illustrates a top-view of the M12 style connector of FIG. 1A;

FIG. 2A illustrates a perspective view of a color-coded M12 style connector known in the art;

FIG. 2B illustrates an exemplary wiring diagram of the M12 style connector of FIG. 2A;

FIG. 3 illustrates a side-view of a contact identification attachment according to an embodiment being used in conjunction with a connector;

FIG. 4 illustrates a top-view of the contact identification attachment of FIG. 3;

FIG. 5 illustrates a top-view of a system for distributing a contact identification attachment according to an embodiment; and

FIG. 6 illustrates a process of utilizing a contact identification attachment in conjunction with a device compatible with augmented reality or virtual reality.

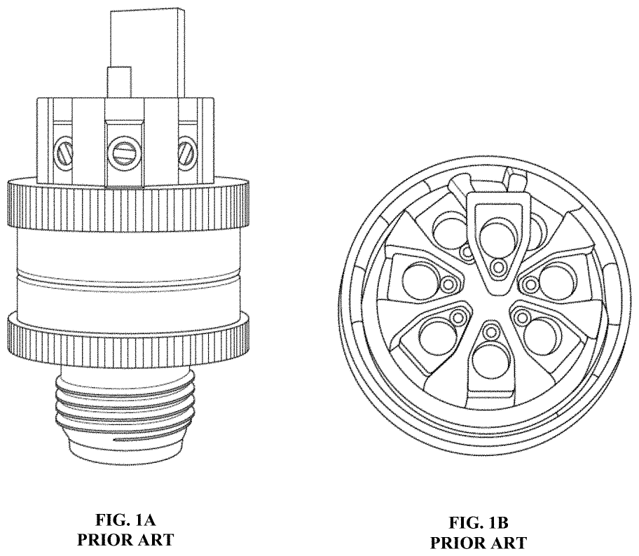

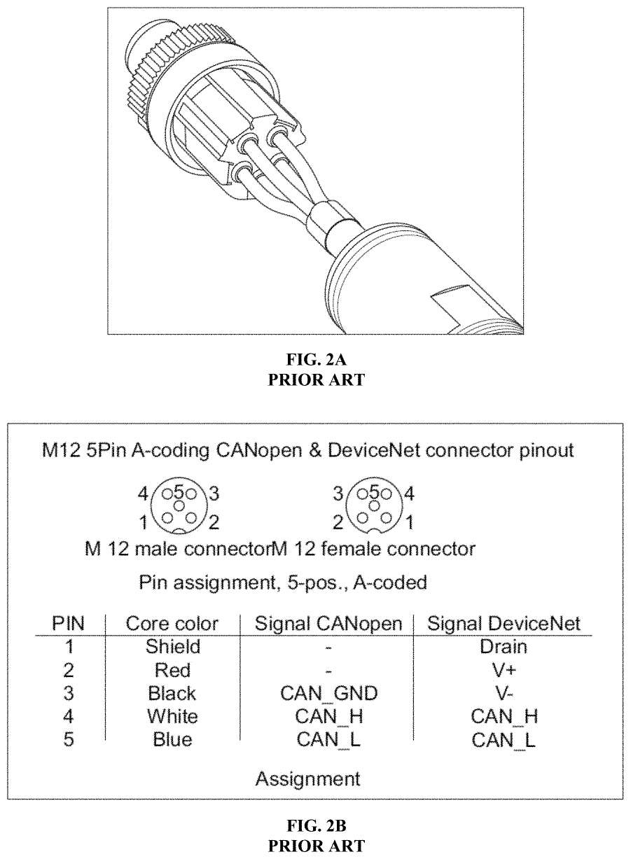

Before explaining the disclosed embodiment of the present invention in detail, it is to be understood that the invention is not limited in its application to the details of the particular arrangement shown, since the invention is capable of other embodiments. Exemplary embodiments are illustrated in the referenced figures of the drawings. It is intended that the embodiments and figures disclosed herein are to be considered illustrative rather than limiting. Also, the terminology used herein is for the purpose of description and not of limitation.

### DETAILED DESCRIPTION

Although this invention is susceptible of embodiments in many different forms, there are shown in the drawings and are described in detail herein specific embodiments with the understanding that the present disclosure is an exemplification of the principles of the invention. It is not intended to limit the invention to the specific illustrated embodiments. The features of the invention disclosed herein in the description, drawings, and claims may be significant, both individually and in desired combinations, for the operation of the invention in its various embodiments. Features from one embodiment may be used in other embodiments of the invention.

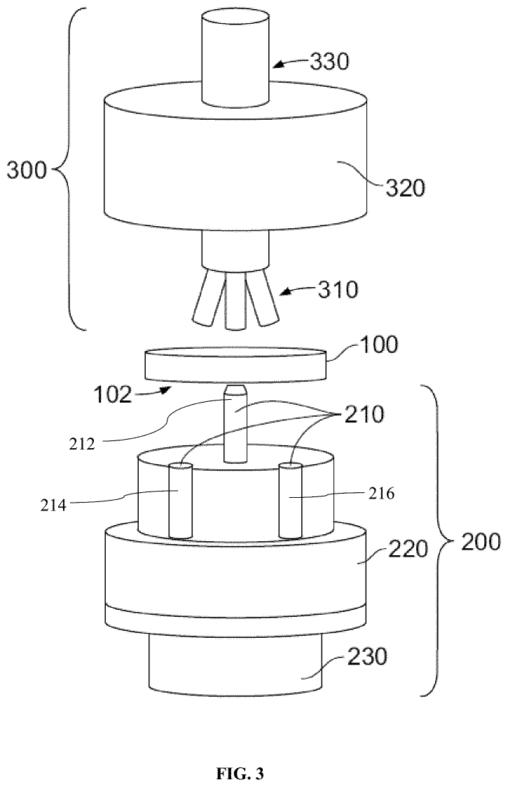

Referring to FIG. 3, a contact identification attachment 100 according to an embodiment may be provided. Specifically, the contact identification attachment 100 may be retrofitted onto an existing connector 200.

The connector 200 may be a M12 style connector, a M8 style connector, or other styles of connectors known in the art. In this example, the connector 200 may include one or more contacts 210. The one or more contacts 210 may or may not be color coded at some locations such as its core or an outer insulator. However, in a common connector, the contacts 210 are unlikely to be color coded. The connector 200 may further include a mechanical front shell 220 and a connector mating body 230.

In addition, a device 300 that needs to be wired with the connector 200 may also be provided. The device may include one or more wires 310 that are to be wired to the corresponding contacts 210 of the connector 200. The wires 310 may or may not be color coded. In cases where the wires 310 are color coded, the color on the individual wire 310 need not match the color of corresponding contacts 210 if the contacts 210 are color coded at all.

The device 300 may further include a mechanical backshell 320 that may be mated with the mechanical front shell 220 of the connector 200 during assembly. The device 300 may further include incoming wire with insulating jacket 330. Moreover, adhesive may be provided on a surface 102 of the contact identification attachment 100 to secure the contact identification attachment 100 to the connector 200 or to the device 300 during assembly.

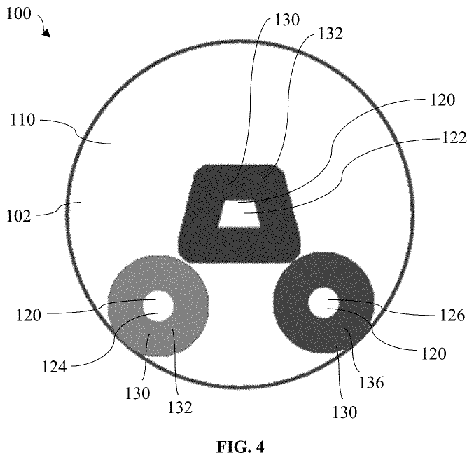

FIG. 4 illustrates a top view of the contact identification attachment 100 according to an embodiment. The contact identification attachment 100 may be of a shape that generally corresponds to a connector that the contact identification attachment 100 is to be attached with. For example, if a connector is circular in shape, the contact identification attachment 100 may also be circular in shape that resembles a disk. Of course, the contact identification attachment 100 needs not match the shape of a connector, and may be in many shapes and sizes.

The contact identification attachment 100 may include an insert 110 that forms the main portion of the contact identification attachment 100. The insert 110 may be made from non-conductive materials such as thin plastic, film, paper cardstock, or the like. The insert 110 may include one or more cutouts 120 that correspond to the one or more contacts of a connector. Using the embodiment shown FIG. 3, where the connector 200 includes three contacts 210 (a first contact 212, a second contact 214, and a third contact 216), the contact identification attachment 100 may be designed to also include three cutouts 120 (a first cutout 122, a second cutout 124, and a third cutout 126) to match the contacts 210. The cutouts 120 may be in the form of a hole or a bore through the contact identification attachment 100, allowing wires to be passed therethrough.

A shape of the cutouts 120 may match the shape of the contacts 210 that the cutouts 120 are designed to be fitted over. By way of example, if a contact 210 (such as the second contact 214 or the third contact 216) is circular in shape, the cutout 120 (such as the second cutout 124 or the third cutout 126) that correspond to such contact 210 may also be circular in shape. Similarly, if a contact 210 (such as the first contact 212) is trapezoidal in shape, the corresponding cutout 120 (such as the first cutout 112) may also be trapezoidal in shape. Nonetheless, it should be noted that the shape of the cutouts 120 need not match their corresponding contacts 210 so long as the cutouts 120 are sizeable enough to run wires therethrough.

The cutouts 120 may also match the locations of the contacts 210 that the cutouts are designed to be fitted over. For example, as shown in FIG. 3, the first contact 212 may be proximal to a center axis of the connector 200, while the second contact 214 and the third contact may be proximal to an edge of the connector 200. In such case, the first cutout 122 (that corresponds to the first contact 212) may also be proximal to a center of the contact identification attachment 100, while the second cutout 124 and the third cutout 126 may have a first relative location with references to the first cutout 122 and with each other similar to a second relative location of the second contact 224 and the third contact 226 with references to the first contact 222 and with each other.

The contact identification attachment 100 may further include indicators 130 near or proximal to each of the cutouts 120. In some embodiments, the indicators 130 may partially or completely surround the corresponding cutouts 120. Using the example provided in FIG. 4, when three cutouts 120 are provided on the contact identification attachment 100, three indicators 130 may also be provided. Here, a first indicator 132 may correspond to the first cutout 122, a second indicator 134 may correspond to the second cutout 124, and the third indicator 136 may correspond to the third cutout 126.

The indicators 130 may take various forms. In an embodiment, the indicators 130 may be color coded. Thus, even if a connector does not come with color coded contacts, the contact identification attachment 100 may be retrofitted onto such connector to color code the contacts. For example, the indicators 130 may be green, red, and purple respectively. In an embodiment, each cutout 120 may have a unique indicator 130 that corresponds to such cutout 120. For example, the first cutout 122 may have the corresponding first indicator 132 in green, the second cutout 124 may have the corresponding second indicator 134 in red, and the third cutout 126 may have the corresponding third indicator 136 in purple, and so forth.

Other types of unique indicators may also be used in addition to or in alternative to color coding. By way of example, in an embodiment, the indicators 130 may include different unique shape markings, such as triangle, circle, square, or the like. In yet another embodiment, indicators 130 may comprise of different symbols or words such as “I”, “II”, “III”, “A”, “B”, “C” or “1”, “2,” “3”, or other appropriate markings. The indicators 130 may be provided on the contact identification attachment 100 through printing, etching, engraving, or other methods known to those skilled in the art.

In some embodiments, the cutouts 120 and/or the indicators 130 may also provide keying when mated with a connector 200 to prevent inadvertent rotation, such as having an additional cutout along an edge of the contact identification attachment 100.

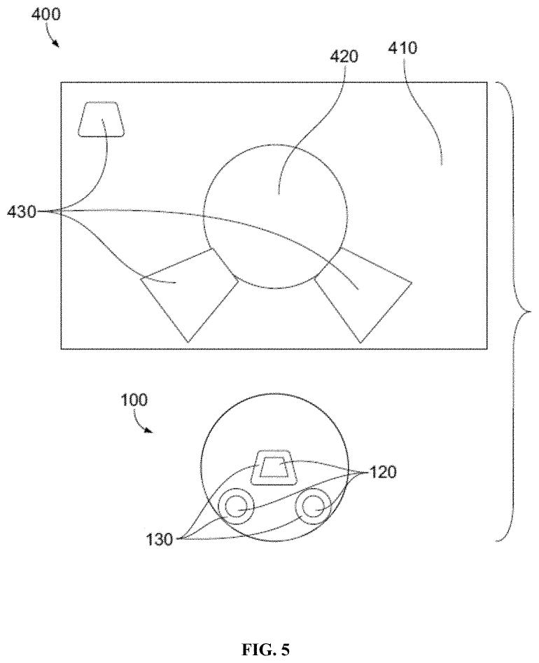

FIG. 5 illustrates an embodiment of a system to distribute the contact identification attachment 100. In an embodiment, a medium 400 may be provided to end users that includes a contact identification attachment 100 therein. The medium 400 may have a similar dimension as a business card or a credit card, such that the medium is easily portable.

The medium 400 may include a card 410 that forms a main portion of the medium 400. The card 410 may be made from any suitable material such as plastic, paper cardstock, or the like. The card 410 may include an attachment cutout 420 for the contact identification attachment 100. In an embodiment, the contact identification attachment 100 may be of a punch-out nature integral to the medium 400. For example, the contact identification attachment 100 may be coupled with the medium 400 through a perforated edge, making the contact identification attachment 100 removable from the medium 400. Thus, during distribution, a user may be given the medium 400 that includes the contact identification attachment 100 attached thereto. Thereafter, the user may remove the contact identification attachment 100 from the medium 400.

The medium 400 may further include portions 430 that contain information relating to the contact identification attachment 100. By way of example, if the corresponding contact identification attachment 100 for the medium 400 includes three cutouts 120, the medium 400 may include three portions 430 that describe various information, such as functions, that correspond to the cutouts 120. The information described in these portions 430 may correspond to the indicators 130 on the corresponding contact identification attachment 100. For example, if the indicators 130 are color coded, the portions 430 may similarly be color coded and provide information pertaining to the respective cutouts 120.

In an example, using the medium 400 as shown in FIG. 5, multiple wiring configurations may be provided using a same contact identification attachment 100. For example, if the indicators 130 of the contact identification attachment 100 are color coded green, red, and purple, instructions may be provided on the medium 400. By way of example, the medium 400 may be printed with instructions such as: “for configuration A, connect red wire to red cutout contact, connect green wire to green cutout contact, and connect purple wire to purple cutout contact; for Configuration B, connect red wire to green cutout contact, connect purple wire to red cutout contact, and connect green wire to purple cutout contact” and the like. Thus, using the contact identification attachment 100, wiring instructions for multiple configurations may easily be conveyed even if a connector does not include color coded contact itself.

Refer back to FIG. 3, in practice, a medium 400 with a contact identification attachment 100 contained therein may be provided to a user. The user may remove the contact identification attachment 100 from the medium 400 in the field and attached the contact identification attachment 100 onto an existing connector 200. The user may align the contact identification attachment 100 with the connector 200 using keying by a property of a cutout 120 (such as a shape) and/or a property of an indicator 130 (such as color coding or other markings). The user may further affix the contact identification attachment 100 on the connector 200 using adhesive or other appropriate means. Thereafter, the user may review instructions provided on the medium 400 (or provided separately), and connect proper wires 310 to the proper contacts 210 using the contact identification attachment 100 as an aid.

In a further embodiment, virtual reality (VR) or augmented reality (AR) may be used in conjunction with a contact identification attachment 100. For example, an AR compatible device (such as a smartphone) may be loaded with an AR application, where when executed, the AR application may utilize a camera, which may be provided on the smartphone or as a standalone camera, to read or recognize indicators 130 of the contact identification attachment 100. The AR application may provide instructions to a user with options for types of installations.

In yet another embodiment, the user may select a type of installation desired by the user, and the AR application may show the proper wiring instruction for the selected type of installation in conjunction with the contact identification attachment 100. As an example, if the indicators 130 are color coded, the AR application may display one or more AR images on the AR compatible device of connecting a first wire to a first contact corresponding to a first cutout and a first indicator of a first color, and connecting a second wire to a second contact corresponding to a second cutout and a second indicator of a second color, and so forth. It should be appreciated that the same or similar methods may also be applied to a VR compatible device (such as a VR headset) loaded with suitable VR application.

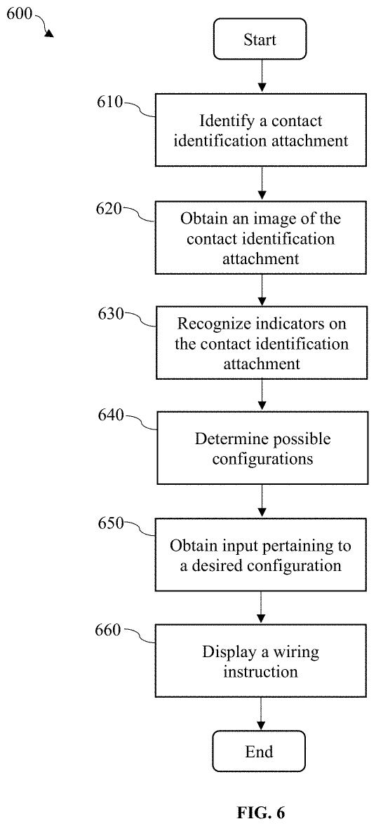

FIG. 6 illustrates a process 600 of utilizing a contact identification attachment utilizing an AR or VR compatible device. The process 600 may be carried out by the compatible device using one or more processors executing program or software stored either on a memory on the device or stored remotely on a server.

At Step 610, the compatible device may identify a contact identification attachment. The compatible device may include or be connected to a camera or other sensors. In some embodiment, a user may initiate an application, a program, or a software on the compatible device that activates the camera. When the contact identification attachment comes into view and range of the camera, the compatible device may recognize that the object in view is a contact identification attachment. For example, this may be achieved through recognizing a size or a dimension of an object at matching a profile the contact identification attachment. As can be appreciated, may variations of the contact identification attachment may exist, and the application or the software may be able to identify many variations of the contact identification attachment.

At Step 620, the camera or the sensor may obtain an image of the contact identification attachment identified in Step 610. In some embodiments, Step 620 may be combined with Step 610 such that a user may manually take a picture (such as pressing a shutter button) to obtain an image, and from the image, the contact identification attachment may be identified.

At Step 630, the application may recognize indicators on the contact identification attachment based on the image taken at Step 620. Alternatively, the indicators may already be recognized based on the identification of the contact identification attachment at Step 610.

At Step 640, the application may determine what possible configurations are supported by the specific contact identification attachment. In some embodiments, the application may determine a specific identity or version of the contact identification attachment based on a number of factors, such as the number of the indicators, the type of the indicators, the shape of the indicators, the order of the indicators, the relative positions of the indicators, or the like.

For example, if the indicators are color coded, the application may recognize the specific color combination as being correspond to a specific contact identification attachment. For example, if the contact identification attachment includes a red indicator, a blue indicator, and a purple indicator, the application may recognize that the contact identification attachment is “Contact Identification Attachment V1”, versus if the contact identification attachment includes a red indicator, a blue indicator, and a green indicator, the application may recognize that the contact identification attachment is “Contact Identification Attachment V2”.

Based on recognizing the specific contact identification attachment, the application may be able to retrieve (such as from a database) the various configurations supported by the specific contact identification attachment. For example, “Contact Identification Attachment V1” may support configurations “A”, “B”, and “C”, while “Contact Identification Attachment V2” may only support configuration “D”. In additional embodiments, identity or version of the specific contact identification attachment, or possible configurations may be provided using machine-reading codes such as a barcode or a QR code.

At Step 650, the compatible device may prompt the user to select a desired configuration. For example, if, at Step 640, it is determined three possible configurations are supported by the specific contact identification attachment, then the compatible device may ask the user to input or select one of the three configurations. Alternatively, if only one configuration is possible, Step 650 may be omitted or skipped.

At Step 660, a wiring instruction corresponding to the selected configuration may be displayed. Depending on the compatible device, the wiring instruction may be provided on a display of the compatible device. The wiring instructions may be augmented on the image taken at Step 620 or may be augmented on a live image or a live video. In some embodiments, the compatible device may recognize a specific wire being manipulated by the user, and display the appropriate wiring instructions, based in part on the selected configuration and the information obtained from the indicators.

Additional steps may be included in the process 600. For example, the user may select a different configuration if multiple configurations are available. Moreover, some steps may be repeated or omitted depending on the specific implementation, and are within the spirit of this disclosure.

Specific embodiments of a contact identification attachment according to the present invention have been described for the purpose of illustrating the manner in which the invention may be made and used. It should be understood that the implementation of other variations and modifications of this invention and its different aspects will be apparent to one skilled in the art, and that this invention is not limited by the specific embodiments described. Features described in one embodiment may be implemented in other embodiments. The subject disclosure is understood to encompass the present invention and any and all modifications, variations, or equivalents that fall within the spirit and scope of the basic underlying principles disclosed and claimed herein.

What is claimed is:

1. A contact identification attachment for a connector comprising:
an insert including a plurality of cutouts; and
a plurality of indicators each corresponding to one of the plurality of cutouts.

2. The contact identification attachment of claim 1, wherein the insert is made from a non-conductive material.

3. The contact identification attachment of claim 1, wherein the indicators are color coded.

4. The contact identification attachment of claim 1, wherein the plurality of cutouts each corresponds to one of a plurality of contacts on a connector.

5. A medium for distributing a contact identification attachment for a connector comprising:
a card that includes an attachment cutout; and
a contact identification attachment secured within the attachment cutout.

6. The medium of claim 5, wherein the contact identification attachment further comprising:
an insert including a plurality of cutouts; and
a plurality of indicators each corresponding to one of the plurality of cutouts.

7. The medium of claim 6, wherein the insert is made from a non-conductive material.

8. The medium of claim 6, wherein the indicators are color coded.

9. The medium of claim 6, wherein the plurality of cutouts each corresponds to one of a plurality of contacts on a connector.

10. The medium of claim 6, further comprising:
at least a portion on the card containing information that corresponds to at least one of the plurality of cutouts.

11. A method for wiring a connector comprising:
affixing a contact identification attachment onto a connector that includes a plurality of contacts; the contact identification attachment includes a plurality of cutouts marked with corresponding indicators; and
wiring one or more wires to the plurality of contacts according to the indicators on the contact identification attachment.

12. The method of claim 11 further comprising affixing the contact identification attachment onto the connector using adhesives.

13. The method of claim 12, further comprising:
providing a device compatible with virtual reality or augmented reality;
recognizing, by the device, indicators on the contact identification attachment; and
providing a wiring instruction, by the device, based on the recognized indicators on the contact identification attachment.

14. The method of claim 13, further comprising:
obtaining an input, by the device, regarding a type of installation,
wherein the wiring instruction corresponds to the type of installation.
